(19) United States
(12) Patent Application Publication
(10) Pub. No.: US 2009/0261502 A1
(43) Pub. Date: Oct. 22, 2009

(54) INTEGRAL MOLDING METHOD OF GASKET OF FUEL CELL-USE COMPONENT MEMBER AND MOLDING DEVICE THEREOF

(75) Inventor: Junichi Arai, Okayama (JP)

Correspondence Address: BACON & THOMAS, PLLC, 625 SLATERS LANE, FOURTH FLOOR, ALEXANDRIA, VA, 22314-1176, US

(73) Assignee: Uchiyama Manufacturing Corp., Okayama (JP)

(21) Appl. No.: 11/991,915

(22) PCT Filed: Sep. 8, 2006
(86) PCT No.: PCT/JP2006/317835

§ 371 Date: Aug. 5, 2008

(30) Foreign Application Priority Data
Sep. 12, 2005 (JP) 2005-263229

(51) Int. Cl. B29C 45/14

(52) U.S. Cl. 264/259; 425/543

(57) ABSTRACT

An integral molding method of gasket of a fuel cell component member in which a gasket body is integrally molded with an outer peripheral portion of a membrane electrode assembly and a peripheral portion of an opening formed on the membrane electrode assembly by cross-linking molding using a mold having a heating means, the membrane electrode assembly comprising a proton exchange membrane, a gas diffusion layer integrally laminated on both sides of the proton exchange membrane via a catalyst carrier layer constituting an electrode. The mold has a cavity corresponding to a molding portion of the gasket body and a heat insulation zone corresponding to a power generating functional portion of the fuel cell component member, a not-cross-linked gasket material is filled in the cavity and the gasket material is molded by heat cross-linking molding using the heating means, whereby a heat generated by molding is prevented from being transmitted to the power generating functional portion by the heat insulation zone. The heat insulation zone is constructed with a recessed portion formed on the mold corresponding to the power generating functional portion, and an inner wall of the recessed portion is attached with a heat insulation material.

### FIELD OF THE INVENTION

The present invention relates to an integral molding method of a gasket of a component member for use in a fuel cell and the molding device thereof, more particularly to an integral molding method of a gasket of a component member for use in a fuel cell in which a gasket body is integrally molded by cross-linking at a peripheral portion of an opening and an outer peripheral portion of a membrane electrode assembly by means of a mold having a heating means. The membrane electrode assembly comprises a proton exchange membrane, a gas diffusion layer integrally laminated on both sides of the proton exchange membrane via a catalyst carrier layer constituting an electrode and the opening is formed along a side of the membrane electrode assembly and to the apparatus thereof.

### PRIOR ART

A membrane electrode assembly (hereinafter called MEA) is comprised of a proton exchange membrane (hereinafter called PEM) made of an ion-exchange membrane such as solid polymer and a gas diffusion layer (hereinafter called GDL) which is integrally laminated on both sides of the PEM via an electrode (anode, cathode) made of a carbon powder including platinum catalyst. Such a MEA is interposed between two separators to constitute a unit cell and a plurality of thus formed unit cells are stacked and integrally fastened, thereby forming a fuel cell body (stack). A flow path for hydrogen gas is formed between one separator and the GDL and a flow path for an oxygen gas (air) is formed between the other separator and the GDL, and further a flow path for cooling medium (water, ethylene glycol and so on) is formed between the separators of the adjacent cells. The electrode where the flow path for hydrogen gas is formed becomes an anode (fuel electrode) and the electrode where the flow path for air (oxygen gas) is formed becomes a cathode (oxygen electrode).

A plurality of manifolds are penetrated along the side of the stack so as to supply and discharge a hydrogen gas, an oxygen gas and a cooling medium and are designed so as to communicate with the above-mentioned flow path for a hydrogen gas, flow path for an oxygen gas and flow path for a cooling medium. Between the MEA and the separator and between the separators are sealed with a gasket in order to prevent leakage of the gas and the cooling medium outside, the gasket being provided around the peripheral portion of an opening formed around the periphery or along the side of the MEA and the outer peripheral portion of the MEA. The gasket and the MEA are integrally attached with an adhesive or a gasket material such as rubber is integrally molded by cross-linking by means of a mold having a heating means.

However, the allowable temperature limit of the PEM interposed with two GDLs is about 130 degrees C., so that there has been such a problem that the heating temperature at cross-linking mold should be set low and a long time should be required in order to prevent damage of the PEM when the gasket and the MEA are integrated by a cross-linking molding. The GDL and the PEM constituting the MEA are thin and delicate film body, therefore when they are damaged, the power generating function as the fuel cell is lost, thereby requiring due attention for handing. However, if the heating temperature is set low in order to prevent the damage of the PEM and long time is spent for a cross-linking molding, the productivity is deteriorated and the mass production at a low cost cannot be achieved.

When a gasket made of rubber is integrally molded by vulcanizing with a steel plate, the heating temperature of the mold of the vulcanized molding is generally set at 150-200 degrees C. If the heating temperature increases 10 degrees C., the heating time is reduced to be half, on the other hand if the heating temperature decreases 10 degrees C., the heating time is increased to be twice. Therefore, when the heating temperature is set low in order to prevent damage of the PEM, the time for hardening rubber becomes very long.

It can be said that vulcanized molding can be achieved in a short time when the heating temperature is high, on the other hand, it needs long time for vulcanizing when the heating temperature is low. Therefore, it can be understood that heating time is very important in order to improve the productivity and to achieve the mass production at a low cost. In case of integrally molding a gasket for use in a fuel cell component member with the MEA, it has been desired to mold them at a heating time of 150-200 degrees C.

There are following prior arts wherein such a member mentioned above having a low allowable temperature limit is not damaged by the heat generated by a cross-linking molding and the productivity is improved.

The patent document 1 discloses that when a rubber is vulcanized to be molded with a plastic product having a lower thermal deformation temperature than the vulcanization temperature of rubber, the plastic product is disposed in a mold preheated lower than the thermal deformation temperature of the plastic and a rubber which is heated to the vulcanization temperature immediately before injection is injected.

The patent document 2 discloses a molding method wherein when rubber is vulcanized to be molded with an insert member made of resin having a low allowable temperature limit, a plurality of split pieces are molded using a mold which sets a split surface at an inserting portion of the insert member and the insert member is intervened between the split pieces while those split pieces remain unvulcanized, then the divided members are molded as an integral rubber.

The patent document 3 discloses a mold for cross-linking molding having a heating means and a cooling means. The fluid circuit for heating or cooling the mold to be formed with a cavity by mating is cast and produced via a carbon fiber bundle which is cast along the shape of the molded product at the back of the molded product and the mold is disposed so as to heat or cool the molten material for the molded material to be injected in the cavity from the back face of the molded product.

### Patent Document 1: JP-A-03-047721

### Patent Document 2: JP-A-2001-219428

### Patent Document 1: JP-A-2004-174606

### DISCLOSURE OF THE INVENTION

### Problems to be Solved in the Invention

However, according to the patent document 1, there is a fear that the temperature of rubber is lowered to make its vulcanization insufficient when rubber passes through a thin injection path provided in a mold and it does not form a gasket for a MEA.

According to the patent document 2, even though the split piece made of rubber is unvulcanized, it has a sufficient heat for vulcanization, so that there is a fear that the insert member to contact with the rubber may be thermally deformed and melted. Further, it has a problem that a timing for intervening the insert member is difficult. Similar to the patent document 1, it does not disclose that a gasket is formed for a MEA.

According to the patent document 3, mainly the temperature is controllable in order to heat or cool the molten material to be injected in a metal mold. It cannot solve the above-mentioned problem that a member having a low allowable temperature limit is prevented from damage caused by the heating of vulcanization molding.

The present invention is proposed according to the above-mentioned problems and has an object to provide an integral molding method of gasket of a fuel cell use component member and its molding device capable of preventing damages of a PEM with a low allowable temperature limit which is constructed as one member of a power generation functional portion of a fuel cell component member, thereby improving the productivity.

### Means to Solve the Problem

The first aspect of the present invention is characterized in that an integral molding method of gasket of a fuel cell component member in which a gasket body is integrally molded with an outer peripheral portion of a membrane electrode assembly and a peripheral portion of an opening formed on the membrane electrode assembly by cross-linking molding using a mold having a heating means, the membrane electrode assembly comprising a proton exchange membrane, a gas diffusion layer integrally laminated on both sides of the proton exchange membrane via a catalyst carrier layer constituting an electrode. The mold has a cavity corresponding to a molding portion of the gasket body and a heat insulation zone corresponding to a power generating functional portion of the fuel cell component member; and a not-cross-linked gasket material is filled in the cavity and the gasket material is molded by heat cross-linking molding using the heating means, whereby a heat generated by molding is prevented from being transmitted to the power generating functional portion by the heat insulation zone.

The power generating functional portion means the portion of MEA where a gasket is not formed.

The second aspect of the present invention is characterized in that, in the method of the first aspect, the heat insulation zone is constructed with a recessed portion formed on the mold corresponding to the power generating functional portion. An air may be circulated in the recessed portion in order to inhibit heat increase in the recessed portion.

The third aspect of the present invention is characterized in that, in the method of the second aspect, an inner wall of the recessed portion is attached with a heat insulation material.

The fourth aspect of the present invention is characterized in that, in the method of the second and the third aspects, the recessed portion includes a cooling block having a cooling medium flow path and being adjacent to the power generating functional portion.

The fifth aspect of the present invention is characterized in that, in the method of the third and the fourth aspects, the cooling block is integrally and fixedly provided with the heat insulation material.

The sixth aspect of the present invention is characterized in that, in the method of the second and the fourth aspects, the cooling block is supported with the inner wall of the recessed portion via a spring so as to form a space and is elastically contacted to the power generating functional portion by an elastic energy of the spring.

The seventh aspect of the present invention is characterized in that an integral molding apparatus of gasket of a fuel cell component in which a gasket body is integrally molded with an outer peripheral portion of a membrane electrode assembly and a peripheral portion of an opening formed on the membrane electrode assembly by cross-linking molding using a mold having a heating means, the membrane electrode assembly comprising a proton exchange membrane, a gas diffusion layer integrally laminated on both sides of the proton exchange membrane via a catalyst carrier layer constituting an electrode. The gasket is integrally molded by way of the cross-linking molding method as set forth in any one of the first through sixth aspects.

### EFFECT OF THE INVENTION

According to the integral molding method and apparatus of gasket of the fuel cell component member described in the first and seventh aspects of the present invention, the gasket is integrally molded using the mold having the heat insulation zone corresponding to the power generating functional portion of the fuel sell component member. The heat transmission to the power generating functional portion of the MEA is prevented by the heat insulation zone, so that the damage (thermal deformation and so on) on the PEM is prevented and the gasket can be integrally molded without adversely affecting on the power generating function of the MEA. Further, the cavity corresponding to the molding portion of the gasket body can be heated at high temperature, thereby reducing the molding and hardening time. Therefore, the productivity can be improved and mass production and low cost can be achieved.

According to the second aspect of the present invention, the heat insulation zone is constructed with a recessed portion formed on the mold. A space is formed between the power generating functional portion and the mold and functions as an effective heat insulation zone, thereby forming a heat insulation zone with a simple structure.

According to the third aspect of the present invention in which the inner wall of the recessed portion is attached with the heat insulation material, the heat insulation effect can be improved with a simple structure.

According to the fourth aspect of the present invention, the recessed portion includes the cooling block having the cooling medium flow path. The power generating functional portion of the MEA is pressed from up and down by the cooling block, so that the heat generated from the heating means can be effectively prevented from being transmitted to the power generating functional portion. Further, the thermal deformation is prevented by cooling, so that the MEA is prevented from being deformed by the molding pressure.

According to the fifth aspect of the present invention, the cooling block is integrally and fixedly provided with the heat insulation material. The heat transmission to the power generating functional portion is blocked by the heat insulation material and the cooling operation of the cooling block does not act on the mold, so that the mold can be kept at a suitable heating temperature. Further, if the temperature in the mold is increased, the rise in the temperature of the power generating functional portion can be prevented by the cooling block. Further, by providing the cooling block, the power generating functional portion of the MEA is pressed from up and down by the cooling block and the deformation of MEA by the molding pressure is prevented.

According to the sixth aspect of the present invention, the cooling block is supported with the inner wall of the recessed portion via the spring so as to form a space and is elastically contacted to the power generating functional portion by the elastic energy of the spring. The heat transmission from the mold can be blocked by the space and the cooling operation by the cooling block does not act on the mold, so that the mold can be kept at a suitable heating temperature. Even if the temperature in the mold is increased, the heat increase of the power generating functional portion can be prevented by the cooling block. Further, by providing the cooling block, the power generating functional portion of the MEA is pressed from up and down by the cooling block and the deformation of MEA by the molding pressure is prevented.

### BRIEF DESCRIPTION OF THE DRAWINGS

FIG. 1 is a diagrammatical perspective view showing one embodiment of a fuel cell assembled with a fuel cell component member obtained by an integral molding method of gasket and its molding device of the present invention.

FIG. 2 is a perspective view of a fuel cell component member obtained by an integral molding method of gasket and its molding device of the present invention.

FIG. 3 is a vertical sectional view of a molding device employed for an integral molding method of a gasket of a fuel cell component material of the present invention.

FIG. 4 is an enlarged view of the portion Y in FIG. 3.

FIG. 5 is a similar view to FIG. 4 showing its modified embodiment.

FIG. 6 is a similar view to FIG. 4 showing its modified embodiment.

FIG. 7 is a similar view to FIG. 4 showing its modified embodiment.

FIG. 8 is a similar view to FIG. 4 of other preferred embodiment.

FIG. 9 is a similar view to FIG. 6 showing its modified embodiment.

### EXPLANATION OF REFERENCE NUMBER

8 proton exchange membrane (PEM)
9 gas diffusion layer (GDL)
9a catalyst carrier layer (cathode)
10 gas diffusion layer (GDL)
10a catalyst carrier layer (anode)
11 opening
12, 13 gasket body recessed portion
15a insulation material
15b space portion
16 cooling block
16a flow path for cooling medium
20 membrane electrode assembly (MEA)
22 mold
23 cavity
A fuel cell component member
S spring

### PREFERRED EMBODIMENTS TO EXECUTE THE INVENTION

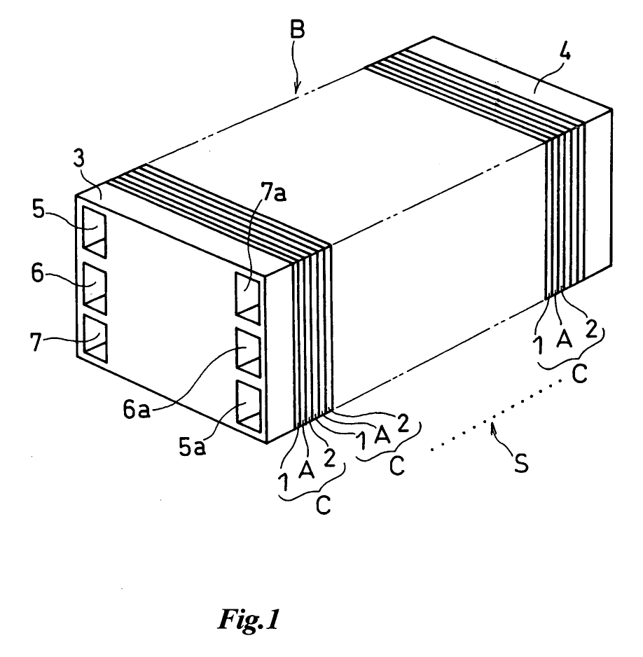

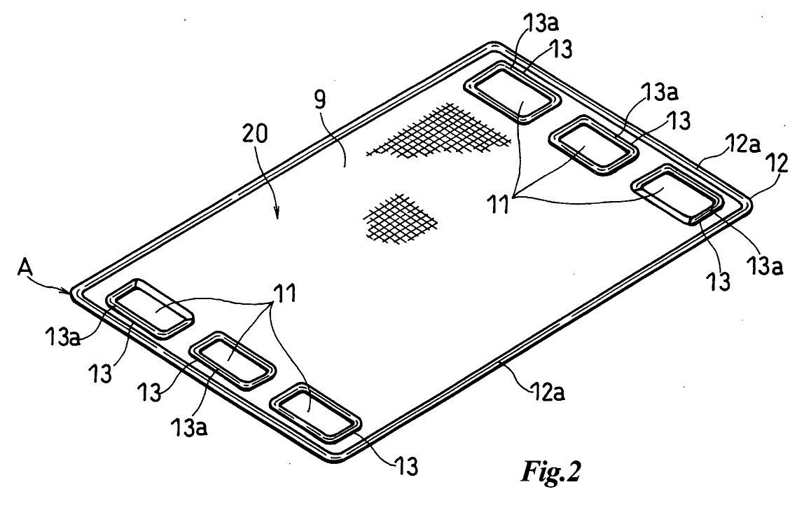

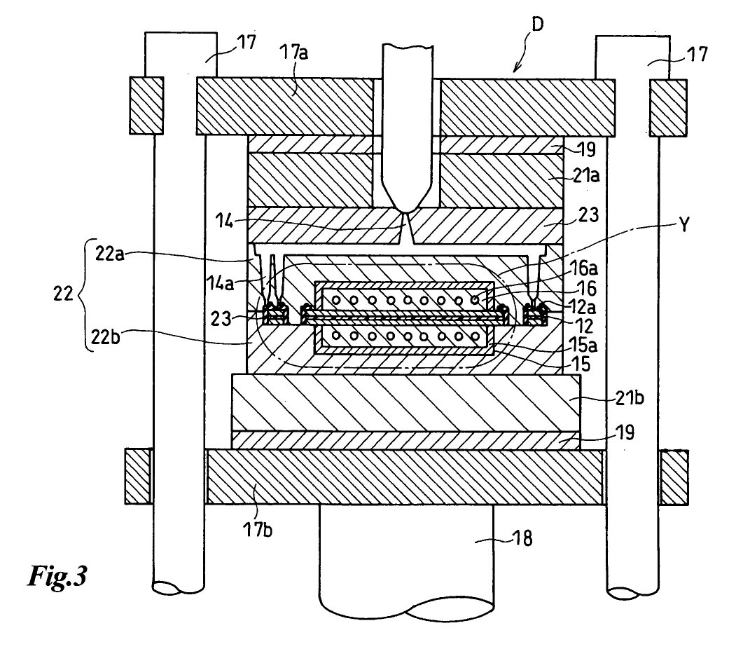

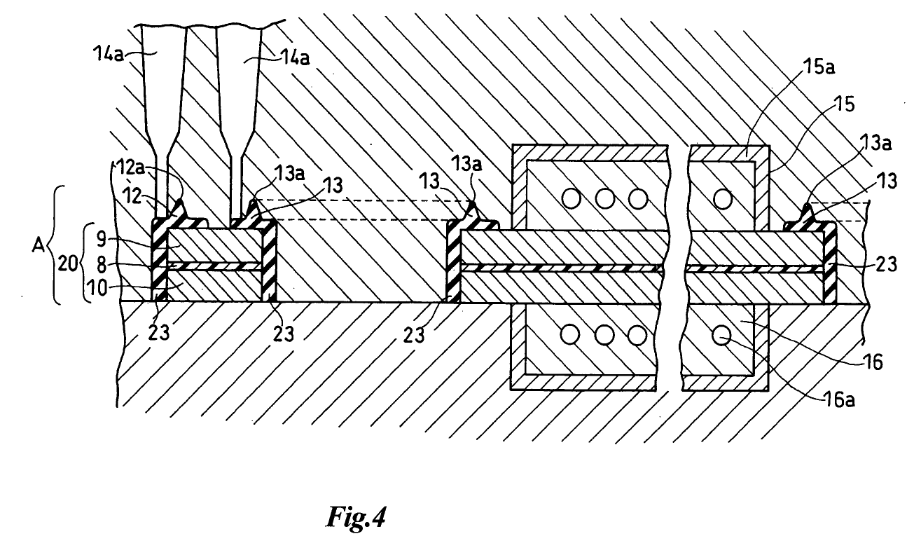

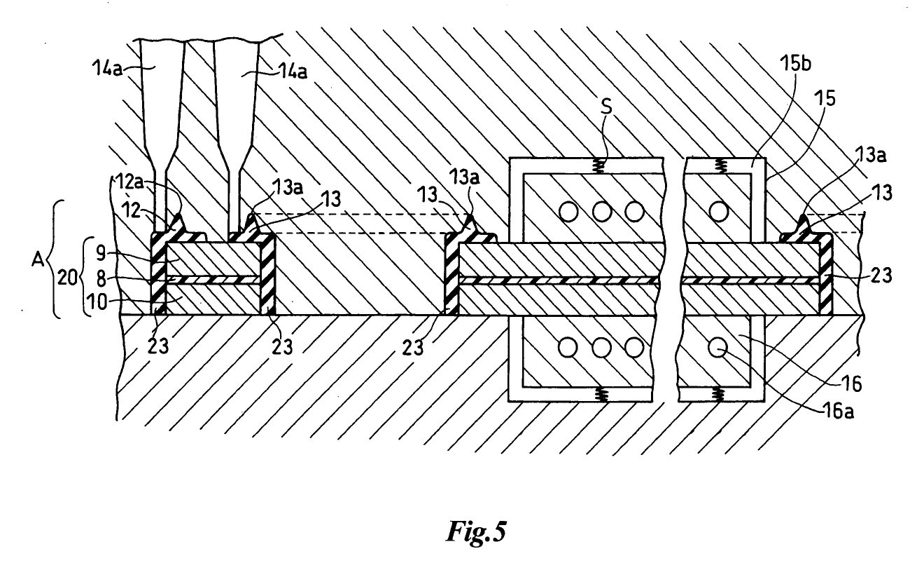

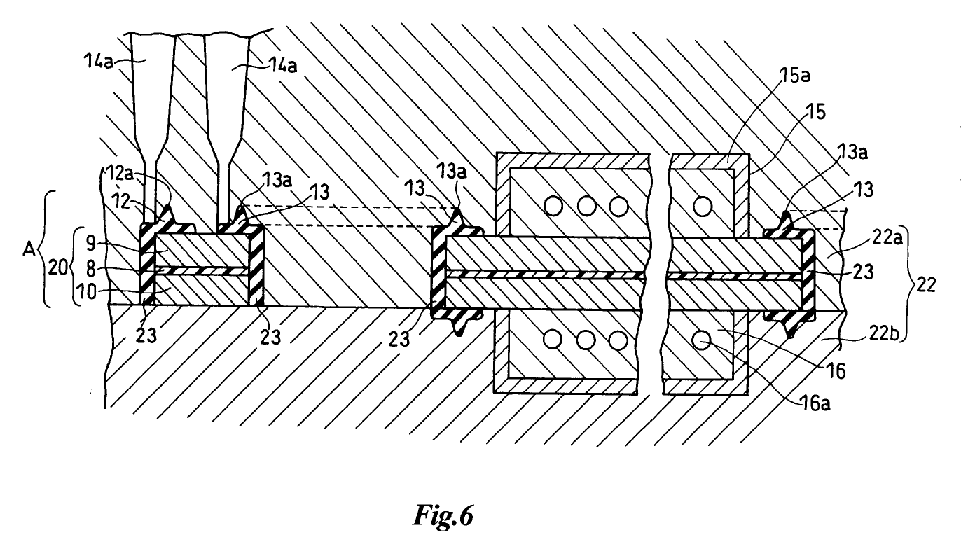

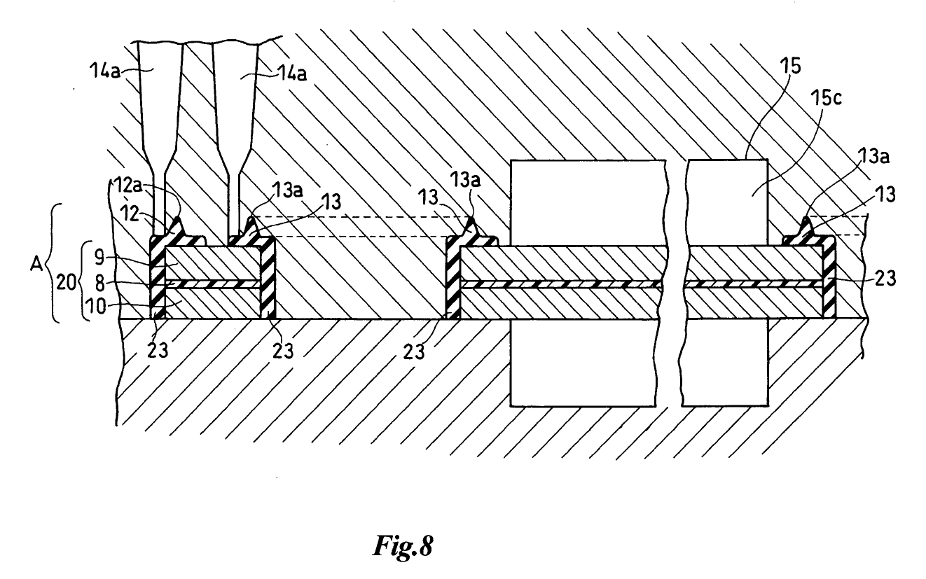

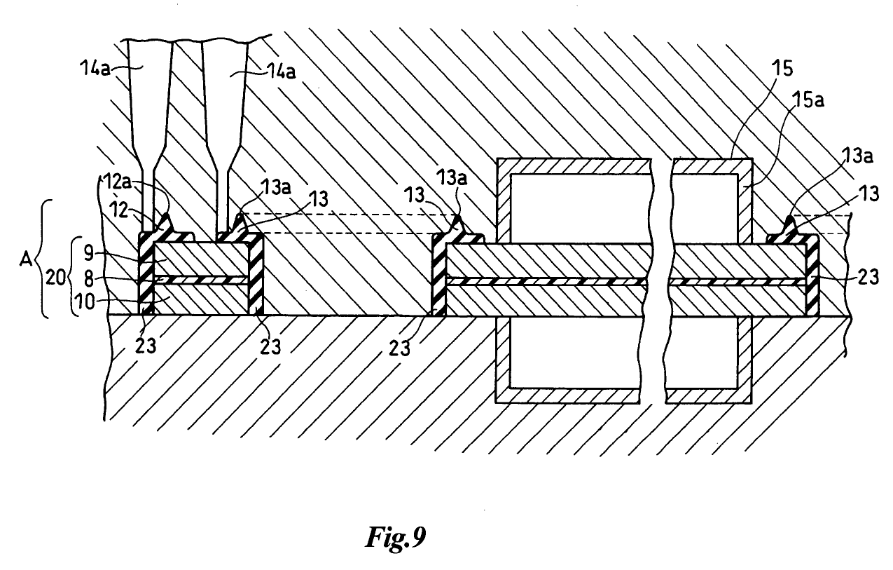

Now, the preferred embodiments of the present invention are explained referring to the drawings. FIG. 1 is a diagrammatical perspective view showing one embodiment of a fuel cell assembled with a fuel cell component member obtained by an integral gasket molding method and its molding device of the present invention, FIG. 2 is a perspective view of a fuel cell component member obtained by an integral gasket molding method and its molding device of the present invention, FIG. 3 is a vertical sectional view of a molding device employed for an integral molding method of a fuel cell component material with a gasket of the present invention, FIG. 4 is an enlarged view of the portion Y in FIG. 3, FIG. 5-FIG. 7 are similar views to FIG. 4 showing its modified embodiments, FIG. 8 is a similar view to FIG. 4 of other preferred embodiment, and FIG. 9 is a similar view to FIG. 6 showing its modified embodiment.

The fuel cell component member A in FIG. 1 is interposed between separators 1, 2 to form a unit cell C and a plurality of thus constructed unit cells C are stacked to form a fuel cell body (stack) S. A current collectors 3, 4 are provided at both ends of the stack S in a stacked direction and the stacks S are integrally bound with the current collectors 3, 4 at both ends by means of a bolt and nut (not shown), thus a fuel cell B is constructed. A plurality of manifolds are provided in a penetrating manner along the longitudinal direction (in the direction of stacking). The manifolds in the figure includes a manifold 5 for supplying a cooling medium (water or ethylene glycol), a manifold 5a for discharging the cooling medium, a manifold 6 for supplying a hydrogen gas, a manifold 6a for discharging the hydrogen gas, a manifold 7 for supplying an oxygen gas (air), and a manifold 7a for discharging the oxygen gas. The cooling medium, the hydrogen gas and the oxygen gas supplied from the manifold 5, 6, 7 respectively are discharged from the manifold 5a, 6a, 7a respectively via a flow path (mentioned later) formed per a unit cell C.

The fuel cell component member A shown in FIG. 1-FIG. 9 includes a MEA 20 constructed such that GDLs 9, 10 are laminated on both sides of PEM 8 to be integrated via a catalyst carrier layer constituting an electrode and gaskets 12, 13 integrally molded by cross-linking at the circumferential portion of an opening 11 and the outer peripheral portion of the MEA 20.

The gaskets 12, 13 are made of a rubber material such as silicone rubber, perfluoroelastomer, butyl rubber, styrene-butadiene copolymer, ethylene-vinyl acetate copolymer, ethylene-acrylic acid methyl copolymer, butadiene rubber, polyisobutylene, fluoro-rubber, ethylene-propylene rubber and the like. The rubber material is vulcanized and molded to be provided for the MEA 20. The chevron portions 12a, 13a of the gaskets 12, 13 are compressed and deformed between the separators 1, 2 at the time of binding mentioned above to keep sealing between the separators 1, 2 by its restoring resilience, so that the cooling medium, the hydrogen gas and the oxygen gas which runs through the flow path or the manifold, mentioned later, are prevented from leaking outside.

The GDLs 9, 10 are made of a sheet of carbon fiber or a metal fiber and its face to the PEM 8 is formed as a catalyst carrier layer (not shown) carrying a platinum catalyst. One side of the catalyst carrier layer to which an oxygen gas is diffused is an oxygen electrode (cathode) and the other side thereof to which a hydrogen gas is diffused is a fuel electrode (anode). The PEM 8 is comprised of a solid polymer ion-exchange membrane and its thickness is about 25 μm, however, the thickness is not limited.

### Embodiment 1

FIG. 3-FIG. 5 show one embodiment of the molding device for integrally vulcanization and molding of a gasket with the above-mentioned MEA. In the figures, a molding device D of injection type is shown, however, it does not mean a pressing/heating molding device is excluded.

The molding device D includes a movable board 17b which moves up and down by a ram 18, a lower mold (split mold) 22a provided above the movable board 17b, a fixed board 17a supported by a pillar 17 above the movable board 17b, and an upper mold (split mold) 22a attached under the fixed board 17a. An upper heating board 21a is provided above the upper mold 22a via an upper runner 23 and a lower heating board 21b is provided under the lower mold 22b. A heat insulation plate 19 is provided between the upper heating board 21a and the fixed board 17a and between the lower heating board 21b and the movable board 17b. An injection path 14 for an unvulcanized rubber is provided at the center of the upper mold 22a so as to communicate with a cavity 23 formed depending on the shape of the gaskets 12, 13 which is integrally formed at the circumferential portion of the opening 11 and the outer peripheral portion of the MEA 20. The unvulcanized rubber to be formed as gaskets 12, 13 by vulcanization molding is filled in the cavity 23 from the injection path 14 via an injection inlet 14a, which is optionally provided in such a manner that the unvulcanized rubber uniformly goes into the cavity 23. The position of the inlet 14a is not limited to that shown in the figure. A drive means for extending the ram 18 and a drive means for the upper heating board 21a and the lower heating board 21b are provided therearound, which are not shown in the figure. A heating means such as an embedded type heater may be used as the upper heating board 21a and the lower heating board 21b.

The mold 22 is comprised of the lower mold 22b and the upper mold 22a, both of split molds 22a, 22b are combined when the movable board 17b rises according to the extension of the ram 18, and the cavity 23 is formed by grinding process between both split molds 22a, 22b for integrally molding the MEA 20 and the gaskets 12, 13 corresponding to the shape of the opening 11 of the MEA 20 as shown in FIG. 2.

The mold 22 has such a cavity 23 and a heat insulation zone blocking heat transmission from the upper heating board 21a and the lower heating board 21b so as not to damage a power generating functional portion of the MEA 20 by the heat generated by molding. The heat insulation zone is constructed with a recessed portion 15 formed on the combined face of the upper and lower molds 22a, 22b corresponding the power generating functional portion. FIG. 3 and FIG. 4 show an embodiment in which a heat insulation material 15a is attached in the inner wall of the recessed portion 15 being the heat insulation zone and a cooling block 16 is provided in the recessed portion 15. A hard resin composite heat insulation plate reinforced with a glass fiber such as FRP may be used as the heat insulation material 15a. The cooling block 16 is provided so as to contact with the power generating functional portion of the MEA 20 and the power generating functional portion is pressed from up and down with the cooling block 16 at the time of vulcanization molding to fasten the entire MEA 20 with the mold 22, thereby preventing deformation of the MEA 20 by the molding pressure.

As shown in FIG. 3 and FIG. 4, when the flow path 16a for a cooling medium is provided in the cooling block 16 so as to circulate a fluid such as a low temperature oil, water, or air in the path 16a, the damage on the power generating functional portion of the MEA 20 is further prevented. Namely, the recessed portion 15 is served for blocking off the heat transmission to the power generating functional portion and the cooling block 16 can cool down the power generating functional portion, so that the power generating thermal portion can be cooled down by the cooling block 16 even when heat is transmitted from the cavity 23 and in addition the cooling effect of the cooling block 16 does not act on the mold 22, thereby enabling to keep the mold at an appropriate heated temperature.

The structure of the mold 22 for preventing damage of the power generating functional portion by the heat generated by vulcanization molding is not limited to the embodiment shown in FIG. 3 and FIG. 4 in which the cooling block 16 is integrally and fixedly provided with the heat insulation material 15a attached on the recessed portion 15. It may be such that a spring S is provided for the inner wall of the recessed portion 15 and the cooling block 16 is supported with the spring S so as to interpose a space portion 15b. In this case, the cooling block 16 is elastically attached to the power generating functional portion by the elastic energy of the spring S, as shown in FIG. 5. Also, the space portion 15b works as a heat insulation layer to shut off the heat transmission and the cooling operation of the cooling block 16 does not act to the mold 22, thereby keeping the mold at an appropriate heated temperature.

The embodiments in FIG. 3-FIG. 5 show that the gaskets 12, 13 are formed on only one side of the MEA 20, however, the present invention is not limited to such an embodiment and is applicable to the embodiments in which the gaskets are provided on both sides of the MEA 20 as shown in FIG. 6. In this case, the cavity 23 is formed on portions corresponding to the gaskets on both sides of the MEA 20.

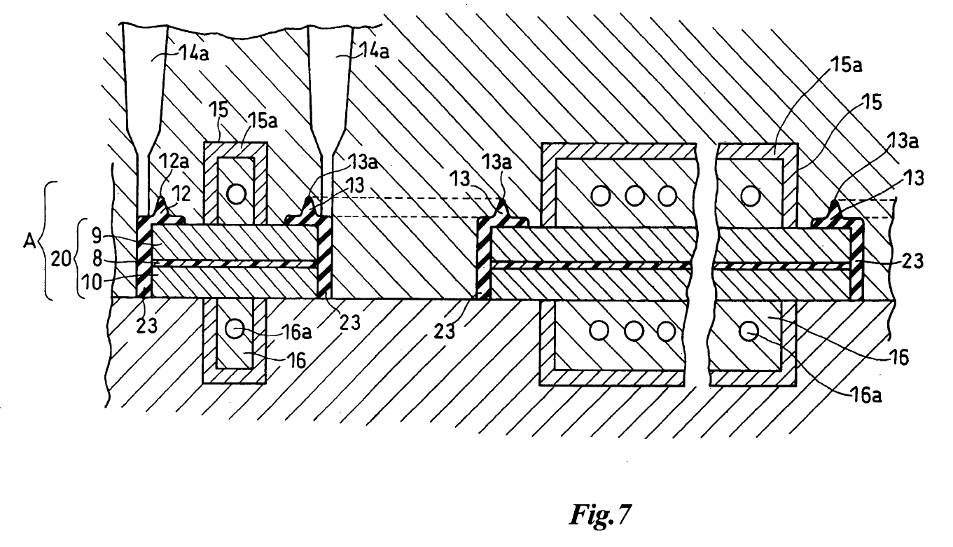

Further, as shown in FIG. 7, the heat insulation zone may be provided between the opening 11 of the MEA 20 and the other periphery of the MEA 20 of the mold 22 (between the gasket 12 and gasket 13).

According to such a structure, the damage caused by the heat can be prevented for a larger area of the MEA 20, so that the zone serving as the power generating functional portion becomes large, attributing increase of power generation as a fuel cell. Because of the increase of the power generation by the enlarged power generating functional portion, the MEA 20 can be downsized by just that much.

### Embodiment 2

FIG. 8 and FIG. 9 show another embodiment of the molding device for integrally vulcanizing and molding the gasket with the MEA. The common members to the embodiment 1 have the same reference numerals and their explanations are omitted here.

In this embodiment, the cooling block 16 of the embodiment 1 is not provided and the recessed portion 15 may be formed in the mold 22. In this embodiment, the damage caused by the heat generated by the power generating functional portion of the MEA 20 can be reduced by a simple structure. In addition, cooling air may be circulated in the recessed portion 15c in order to improve its effect.

Further, the heat insulation member 15a may be attached on the inner wall of the recessed portion 15 like the embodiment 1.

In the embodiment in FIG. 8 and FIG. 9, the gaskets 12, 13 are formed on only one side of the MEA 20, however, the present invention is applicable to the embodiment in which they are provided for both faces of the MEA 20 as shown in the embodiment 1 in FIG. 6. In this case, the cavity 23 is provided on portions corresponding to the gaskets on both faces of the MEA 20.

Still further, as shown in the embodiment 1 of FIG. 7, the heat insulation zone may be provided between the opening 11 of the MEA 20 and the outer periphery of the MEA 20 (between the gasket 12 and the gasket 13), as explained referring to the embodiment 1.

According to such a structure, the damage caused by the heat can be prevented for a larger area of the MEA 20, so that the zone serving as the power generating functional portion becomes large, attributing increase of power generation as a fuel cell. Because of the increase of the power generation by the enlarged power generating functional portion, the MEA 20 can be downsized by just that much.

It cannot be said that the entire configuration of the fuel cell to which the fuel cell component member A of the present invention is incorporated, the shape of each manifold and the corresponding through holes for the manifold, and the structure of the molding device are not limited to those shown in the figure. The material of gasket is not limited to the above-mentioned rubber and a not-crosslinked soft resin may be applicable.

1. An integral molding method of gasket of a fuel cell component member in which a gasket body is integrally molded with an outer peripheral portion of a membrane electrode assembly and a peripheral portion of an opening formed on said membrane electrode assembly by cross-linking molding using a mold having a heating means, said membrane electrode assembly comprising a proton exchange membrane, a gas diffusion layer integrally laminated on both sides of said proton exchange membrane via a catalyst carrier layer constituting an electrode, wherein:
said mold has a cavity corresponding to a molding portion of said gasket body and a heat insulation zone corresponding to a power generating functional portion of said fuel cell component member; and
a not-cross-linked gasket material is filled in said cavity and said gasket material is molded by heat cross-linking molding using said heating means,
whereby a heat generated by molding is prevented from being transmitted to said power generating functional portion by said heat insulation zone.

2. The integral molding method of gasket of a fuel cell component member as set forth in claim 1, wherein said heat insulation zone is constructed with a recessed portion formed on said mold corresponding to said power generating functional portion.

3. The integral molding method of gasket of a fuel cell component member as set forth in claim 2, wherein an inner wall of said recessed portion is attached with a heat insulation material.

4. The integral molding method of gasket of a fuel cell component member as set forth in claim 2 or 3, wherein said recessed portion includes a cooling block having a cooling medium flow path and being adjacent to said power generating functional portion.

5. The integral molding method of gasket of a fuel cell component member as set forth in claim 3 or 4, wherein said cooling block is integrally and fixedly provided with said heat insulation material.

6. The integral molding method of gasket of a fuel cell component member as set forth in claim 2 or 4, wherein said cooling block is supported with said inner wall of said recessed portion via a spring so as to form a space and is elastically contacted to said power generating functional portion by an elastic energy of said spring.

7. An integral molding apparatus of gasket of a fuel cell component in which a gasket body is integrally molded with an outer peripheral portion of a membrane electrode assembly and a peripheral portion of an opening formed on said membrane electrode assembly by cross-linking molding using a mold having a heating means, said membrane electrode assembly comprising a proton exchange membrane, a gas diffusion layer integrally laminated on both sides of said proton exchange membrane via a catalyst carrier layer constituting an electrode, wherein:
said gasket is integrally molded by way of the cross-linking molding method as set forth in any one of claims 1-6.
